(19) United States
(12) Patent Application Publication
(10) Pub. No.: US 2024/0012203 A1
(43) Pub. Date: Jan. 11, 2024

(54) OPTICAL FILTER AND METHODS

(71) Applicant: Telefonaktiebolaget LM Ericsson (publ), Stockholm (SE)

(72) Inventors: Alessandra BIGONGIARI, Pisa (IT); Alberto BIANCHI, Pisa (IT); Fabio CAVALIERE, Pisa (IT)

(21) Appl. No.: 18/036,280

(22) PCT Filed: Nov. 19, 2020
(86) PCT No.: PCT/EP2020/082765

§ 371 Date: May 10, 2023

(51) Int. Cl. G02B 6/293; G02B 6/12; H04J 14/02

(52) U.S. Cl. CPC G02B 6/29343; G02B 6/12007; H04J 14/021

(57) ABSTRACT

An optical filter for an optical network is disclosed, the optical filter adaptively adds or removes a target wavelength in a predetermined filter range, the optical filter comprising: a first resonator having a first resonant wavelength outside a first sub-range of the predetermined filter range when a first resonance control variable of the first resonator is set at a first value, and a second resonant wavelength inside the first sub-range of the predetermined filter range when the first resonance control variable of the first resonator is set at a second value; and a second resonator having a third resonant wavelength outside a second sub-range of the predetermined filter range when a second resonance control variable of the second resonator is set at a third value, and a fourth resonant wavelength inside the second sub-range of the predetermined filter range when the second resonance control variable of the second resonator is set at a fourth value.

### TECHNICAL FIELD

Embodiments of the disclosure generally relate to an optical filter, and, more particularly, to an optical filter for an optical network.

### BACKGROUND

This section introduces aspects that may facilitate better understanding of the present disclosure. Accordingly, the statements of this section are to be read in this light and are not to be understood as admissions about what is in the prior art or what is not in the prior art.

Tunable optical filters can have a key role in the deployment of wavelength-division multiplexing (WDM) networks in order to select an arbitrary reception wavelength at any port. They can be either used to realize reconfigurable optical add drop multiplexers (ROADMs) or can be embedded in a WDM transceiver, in front of a photodetector. In both cases, tunable optical filters introduce flexibility in the planning of the network and its upgrade, and enables SW reconfiguration, reducing inventory costs.

When used in ROADMs, tunable optical filters relieve operators deploying and storing many variants of fixed optical add drop multiplexers (OADMs) where each fixed OADM corresponds to a specific group of wavelengths, replacing the fixed OADMs with a single reconfigurable device. This leads to advantages in network planning simplification and saving of costs for the acquisition and maintenance of backup components (spare parts), which are necessary to cope with possible failures, as failures can be addressed with a single spare tunable device.

When a tunable optical filter is embedded in a WDM transceiver, transceivers with such embedded tunable filters can be employed in scenarios where a WDM network exploits an existing access network infrastructure configured with passive splitters, which do not have wavelength selection capability. This would be the case of a WDM network overlaying an existing passive optical network (PON), used, for example, to access 5G towers with a bi-directional connection.

An example of a WDM overlaying a PON enabled by tunable filters is illustrated in FIG. 1. As is illustrated in this Figure, a centralized unit (CU) or a distributed unit (DU) (or both) 101 are provided at the central office 103 and are configured to send a signal comprising first, second, third and fourth wavelengths (λ₁, λ₂, λ₃, λ₄) to an optical distribution node (ODN), including a wavelength distribution node, for example based on an arrayed waveguide grating (AWG) 105. An optical line terminal (OLT) 107 is provided at the central office and is configured to transmit signals for the PON network. The OLT may be configured to convert, frame and transmit signals for the PON network and coordinate the optical network terminals multiplexing for the shared upstream transmission. The OLT sends signals to a coexistence optical filter in the ODN, that multiplexes the signal comprising the first, second, third and fourth wavelengths with the upstream and downstream wavelengths of the PON.

A signal is sent from the AWG to a first splitter 109 which extracts a first and second wavelength, λ₁, λ₂, from the signal and sends these wavelengths to a first plug 113. The signal is sent from the first splitter to a second splitter 111, which extracts a third and fourth wavelength, λ₃, λ₄, and sends these wavelengths to a second plug 115 (e.g. a 5G tower). The signal is sent from the second splitter to an optical network terminal (ONT) 117, for example, an end user device.

In this scenario, the splitters, or tunable transceivers, may include a tunable filter capable of selecting a WDM channel in the upstream (TX) or downstream (RX) band, with a typical channel spacing of 100 GHz and isolation >20 dB. Separate bands are usually allocated for uplink spacing (US) and downlink spacing (DS) in WDM transmission, for example 1528.77-1543.73 nm and 1547.72-1563.05, respectively.

Presently, commercial tunable filters are based on Micro-Electro-Mechanical Systems (MEMS), miniaturized electro-mechanical elements that allow wavelength selection by moving a micro-mirror.

FIG. 2 illustrates the operating principle of a tunable filter based on a MEMS mirror 219. The tunable filter comprises an optical system where light from an input fiber 221 is collimated on a fused silica grating 227 that diffracts the light with a distinct angle for each wavelength. Light is then reflected by a MEMS mirror 219 onto an output collimator 223 which couples a fraction of it into the output fiber 225. By modifying the MEMS mirror tilt angle, it is possible to tune the central wavelength of the filter.

However, the power consumption of MEMS based filters may be excessive for integration in pluggable modules. Furthermore, the cost of MEMS based filter is high for the scale of the application in scenarios such as 5G access networks and data centers. The high cost is due to due to their complex mechanical structures based on free space optics and 3-dimensional movements of micro-mirrors. In addition, there are few solutions allowing the fabrication of MEMS based filters through CMOS compatible processes (which are available in a standard electronic production line). This may prevent reduction in costs even for large volume fabrication.

A second solution available in commercial products is thin film filters. These are stacks of dielectric layers with thickness equal to a quarter of the central passband wavelength. A cavity layer of a quarter wavelength is added to form a resonator with two groups of dielectric film stacks acting as reflectors. Wavelength tuning is achieved by varying the incident angle of the incoming light beam.

The properties of the filter are determined by the number of layers and the optical properties of the dielectrics. Commonly used materials are silica (Sift) as the low-index layer and tantalum pentoxide (Ta₂O₅) as the high-index layer. These materials have a high refractive index contrast, which reduces the number of layer pairs required for narrow passband and low passband loss. The typical size is 2 mm². Three main deposition techniques are used to achieve performances compatible with e.g. DWDM filtering applications: ion beam assisted deposition (IBAD), plasma-assisted deposition (PAD), and ion beam sputtering (IBS). These techniques use ion beams to bombard the target materials while they are condensing on the substrate with the aim of preventing voids and imperfections in the material and improving yield.

However, the power consumption of thin film filters may be excessive. Furthermore, the cost of thin film filters (associated to fabrication process and the cost of the controls associated to incidence angle variation) is relatively high for 5G access networks and data centers. In addition, thin film filters with tunable functions cannot be integrated in a silicon photonic chip with standard CMOS compatible processes, and the footprint of the filter is large compared to the total area of a photonic chip.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for reducing cost and power consumption of optical filters.

According to a first aspect of the disclosure, there is provided an optical filter for an optical network. The optical filter is configured to adaptively remove or add a target wavelength in a predetermined filter range. For example, the optical filter may pass, drop or filter (remove or add) any target wavelength in the predetermined filter range. The optical filter comprises a first resonator configured to have a first resonant wavelength outside a first sub-range of the predetermined filter range when a first resonance control variable of the first resonator is set at a first value. The first resonator is also configured to have a second resonant wavelength inside the first sub-range of the predetermined filter range when the first resonance control variable of the first resonator is set at a second value. The optical filter also comprises a second resonator configured to have a third resonant wavelength outside a second sub-range of the predetermined filter range when a second resonance control variable of the second resonator is set at a third value. The second resonator is also configured to have a fourth resonant wavelength inside the second sub-range of the predetermined filter range when the second resonance control variable of the second resonator is set at a fourth value. Each resonator may be independently controllable.

Thus, an optical filter is provided that may use a first resonator to filter wavelengths in a first sub-range of a predetermined filter range, and may use a second resonator to filter wavelengths in a second sub-range of a predetermined filter range. By using two resonators to each filter a portion of the predetermined filter range, the resonant wavelength of each resonator does not need to be altered as much as would have been necessary were only one resonator used to filter wavelengths over the whole predetermined filter range. As such, less power may be needed in order to move a resonator to the target wavelength.

The resonance control variable may be a voltage of an electrical gate of the resonator. The resonance control variable may be the temperature of the resonator.

The resonators may be configured so that, when a resonator is in an “off” configuration (a non-operating configuration, a configuration where the minimum amount of power is consumed, where no power or heat is intentionally supplied to the resonator), the resonant wavelength of the resonator is outside of the predetermined filter range. When a resonator is in an “on” configuration (an operating configuration, a configuration where more power is consumed than the “off” configuration), in which power or heat is supplied (intentionally) to the resonator, the resonant wavelength of the resonator may be altered to a wavelength inside the predetermined filter range. The predetermined filter range may be a range of wavelengths which it is determined that the optical filter should be able to filter. This may be determined by the required wavelengths of channels in an optical system in which the optical filter is to be used. The predetermined range may be set by the design of the resonators, where the resonators are designed (using certain dimensions, material, etc.) to allow them to have a resonant wavelength outside the predetermined filter range when no heat or power is supplied to the resonator, but also to be operable to have a resonant wavelength inside the predetermined filter range when heat or power is supplied to the resonator.

The optical filter may be configured to selectively alter the first resonance control variable of the first resonator to the second value which is a value at which the second resonant wavelength corresponds to the target wavelength (e.g, a value at which the second resonant wavelength is, or moves to, the target wavelength). The optical filter may be configured to selectively alter the second resonance control variable of the second resonator to the fourth value which is a value at which the fourth resonant wavelength corresponds to the target wavelength (e.g, a value at which the fourth resonant wavelength is, or moves to, the target wavelength).

When the target wavelength is closest to the first resonant wavelength, the first resonance control variable of the first resonator may be altered. When the target wavelength is closest to the third resonant wavelength, the second resonance control variable of the second resonator may be altered.

Thus, less power may be used in order to move the resonant wavelength of a resonator to the target wavelength.

The optical filter may be configured to alter the value of the first resonance control variable of the first resonator when the target wavelength is in the first sub-range. The optical filter may be configured to alter the value of the second resonance control variable of the second resonator when the target wavelength is in the second sub-range. When the target wavelength is in the first sub-range, the second resonator may be configured to have the third resonant wavelength, and when the target wavelength is in the second sub-range, the first resonator may be configured to have the first resonant wavelength.

The second resonator may be configured so that the second resonance control variable is alterable to a fifth value so as to generate a resonant wavelength in the first sub-range of the predetermined filter range if the first resonance control value cannot be altered from the first value to the second value. For example, where there is a failure relating to the first resonator, e.g. in a controller such as a heater which alters the first resonance control value, the second resonator may also be operated over the first sub-range (the second resonator operates over the whole pre-determined filter range). A resonator may be considered to fail when it is not possible for the resonant wavelength of a resonator to move into the sub-band which they are intended to serve in normal use.

It will be appreciated that the opposite may also be true, where the first resonance control variable is alterable to a sixth value so as to generate a resonant wavelength in the second sub-range of the predetermined filter range if the second resonance control value cannot be altered from the third value to the fourth value.

Thus, the lifetime of the optical filter may be extended as the optical filter may continue to filter wavelengths in the predetermined filter range even if there is a failure associated with one of the resonators.

The first sub-range may extend over substantially half of the predetermined filter range. The second sub-range may make up substantially the remaining portion of the predetermined filter range (or vice versa). The first sub-range and the second sub-range may each cover half the predetermined filter range.

The first sub-range and the second sub-range may be separated by a guard range. The predetermined filter range may exclude the guard range. The guard range may be a set of wavelengths which are not used (e.g. by the optical system).

The first resonant wavelength may be in the guard range when the first resonance control variable of the first resonator is set at the first value. The third resonant wavelength may be in the guard range when the second resonance control variable of the second resonator is set at the third value.

The first resonant wavelength may be outside the predetermined filter range when the first resonance control variable of the first resonator is set at the first value. The third resonant wavelength may be outside the predetermined filter range when the second resonance control variable of the second resonator is set at the third value. It will be appreciated that the outside of the predetermined filter range may be above or below the upper or lower boundaries of the predetermined filter range respectively, or in the guard band (which may be a region excluded from the predetermined filter range).

The first and/or third resonant wavelength may be a wavelength shorter than a lower boundary of the predetermined filter range. The first and/or third resonant wavelength may be a wavelength longer than an upper boundary of the predetermined filter range.

The first sub-range and the second sub-range may not overlap.

The optical filter may comprise a first heater and a second heater. The optical filter may be configured to heat the first resonator using the first heater and the second resonator using the second heater.

By using two separate heaters corresponding to the two resonators, if one heater fails, the other may continue to operate so that resonant wavelengths over the whole predetermined filter range may be filtered.

The first value may be a first temperature which is a temperature of the first resonator when the first resonator is not heated by the first heater. The third value may be a third temperature which a temperature of the second resonator when the second resonator is not heated by the second heater.

The first heater may comprise a first resistor. The second heater may comprise a second resistor. At least one of the first heater and the second heater may be formed from one of: titanium, titanium nitride.

The first value and the third value may be an ambient temperature (e.g. a temperature at which a resonator is substantially the same temperature as the rest of the optical filter).

At the first value a first free spectral range of the first resonator may be greater than the predetermined filter range. At the third value a second free spectral range of the second resonator may be greater than the predetermined filter range.

The optical filter may comprise no more than two resonators. For example, the optical filter may comprise one resonator for operating in the first sub-range, and one resonator for operating in the second sub-range. It will, however, be appreciated that each of these two resonators may comprise more than one resonator element, such as a ring resonator or a Bragg resonator. Thus, one of the two resonators may comprise a plurality of resonator elements, and the other of the two resonators may comprise a plurality of resonator elements.

The optical filter may comprise a plurality of resonators each having a resonant wavelength outside the predetermined filter range when the respective resonance control value of the resonators is at an off (non-operating) value, and having a resonant wavelength inside the predetermined filter range when the respective resonance control value of the resonators is at an on (operating) value. Each resonator may operate over a different sub-range of the predetermined filter range in normal use.

An advantage of having a plurality of resonators is that each can be operable over a portion of the predetermined filter range, but if a failure occurs, a resonator may be operable to cover their portion as well as the portion of the failed resonator.

The first resonator may comprise a first ring resonator. The second resonator may comprise a second ring resonator. The first ring resonator and the second ring resonator may comprise different radii. The first resonator may comprise a first plurality of ring resonators. The second resonator may comprise a second plurality of ring resonators.

At least one of the first resonator and the second resonator may comprise a Bragg resonator (reflector).

At least one of the first resonator and the second resonator may comprise silicon.

The first resonator and the second resonator may be optically coupled to an input waveguide (e.g. a throughput, bus) for inputting light to the first resonator and the second resonator. The light input to the first resonator and the second resonator may comprise light corresponding to the target wavelength. The target wavelength may be removed from the light passing through the input waveguide.

At least one of the first resonator and the second resonator may be optically coupled to at least one output waveguide (e.g. drop) for receiving a resonant wavelength of at least one of the first resonator and the second resonator (the resonant wavelength may be added to the output waveguide). At least one of the first resonator and the second resonator may be optically coupled to at least one output waveguide from which the resonant wavelength of at least one of the first resonator and the second resonator is removed (e.g. the wavelength may be removed from the throughput). A waveguide which both inputs the target wavelength to the resonator and outputs a signal which does not comprise the target wavelength may be considered to be both an input and an output waveguide, or a throughput waveguide. Thus, the target wavelength may be added to or removed from the output of the optical filter.

The target wavelength may be a wavelength of a channel to be added or dropped in the optical network. The optical network may be a wavelength-division multiplexing network.

In a further aspect of the disclosure, there is provided an optical network comprising the optical filter.

In a further aspect of the disclosure, there is provided a method for using the optical filter. The method comprises altering a first resonance control variable of a first resonator from a first value to a second value, wherein the first resonator comprises a first resonant wavelength outside a first sub-range of the predetermined filter range when the first resonance control variable of the first resonator is at the first value, and a second resonant wavelength inside the first sub-range of the predetermined filter range when the first resonance control variable of the first resonator is at the second value, or altering a second resonance control variable of a second resonator from a third value to a fourth value, wherein the second resonator comprises a third resonant wavelength outside a second sub-range of the predetermined filter range when the second resonance control variable of the second resonator is at the third value and a fourth resonant wavelength inside the second sub-range of the predetermined filter range when the second resonance control variable of the second resonator is at the fourth value.

The method may further comprise altering the first resonance control variable of the first resonator to the second value which is a value at which the second resonant wavelength corresponds to the target wavelength, or the second resonance control variable of the second resonator to the fourth value which is a value at which the fourth resonant wavelength corresponds to the target wavelength.

When the target wavelength is closest to the first resonant wavelength, the first resonance control variable of the first resonator may be altered. When the target wavelength is closest to the third resonant wavelength, the second resonance control variable of the second resonator may be altered.

The method may further comprise altering the value of the first resonance control variable of the first resonator when the target wavelength is in the first sub-range. The method may further comprise altering the value of the second resonance control variable of the second resonator when the target wavelength is in the second sub-range.

The method may further comprise altering the second resonance control variable to a fifth value so as to generate a resonant wavelength in the first sub-range of the predetermined filter range if the first resonance control value cannot be altered from the first value to the second value, and/or the first resonator (304) is configured so that the first resonance control variable is alterable to a sixth value so as to generate a resonant wavelength in the second sub-range of the predetermined filter range if the second resonance control value cannot be altered from the third value to the fourth value.

Altering the second resonance control variable to a fifth value so as to generate a resonant wavelength in the first sub-range of the predetermined filter range may occur if a failure relating to the first resonator is detected (e.g. in the optical system or by the optical filter). Altering the first resonance control variable to a sixth value so as to generate a resonant wavelength in the second sub-range of the predetermined filter range may occur if a failure relating to the second resonator is detected.

The method may further comprise receiving light input to the optical filter. The method may further comprise outputting light from the optical filter.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a WDM overlaying a PON enabled by tunable filters;

FIG. 2 is a diagram illustrating a tunable filter based on a MEMS mirror;

FIG. 3 is a diagram illustrating an optical filter according to an example;

FIG. 4 is a diagram illustrating a method for an optical filter according to an example;

FIG. 5 is a diagram illustrating movement of the resonant wavelength of a first resonator and a second resonator into a predetermined filter range according to an example;

FIG. 6a is a diagraph illustrating the movement of resonant wavelengths of the first and second resonators in normal use according to an example;

FIG. 6b is a diagraph illustrating the movement of resonant wavelengths in normal use according to an example;

FIG. 7 is a diagram illustrating the movement of resonant wavelengths of the first and second resonators over the whole predetermined filter range according to an example;

FIG. 8 is a diagram illustrating an optical filter comprising a ring resonator according to an example;

FIG. 9 is a diagram illustrating an optical filter comprising two resonators each comprising a ring resonator according to an example;

FIG. 10a is a diagram illustrating an optical filter comprising two heaters according to an example;

FIG. 10b is a 3D diagram illustrating the optical filter of FIG. 10a according to an example;

FIG. 10c is a graph illustrating the correlation between an increase in temperature and the change in resonant wavelength of a ring resonator according to an example;

FIG. 11a is a diagram illustrating a ring resonator according to an example;

FIG. 11b is a 3D diagram illustrating the ring resonator of FIG. 11a according to an example;

FIG. 12 is a diagram illustrating an optical filter comprising two resonators each comprising two ring resonators according to an example;

FIG. 13 is a graph illustrating the filter profile for a resonator comprising one ring resonator, two ring resonators and three ring resonators according to an example; and

FIG. 14 illustrates an optical filter comprising two resonators each comprising a Bragg resonator according to an example.

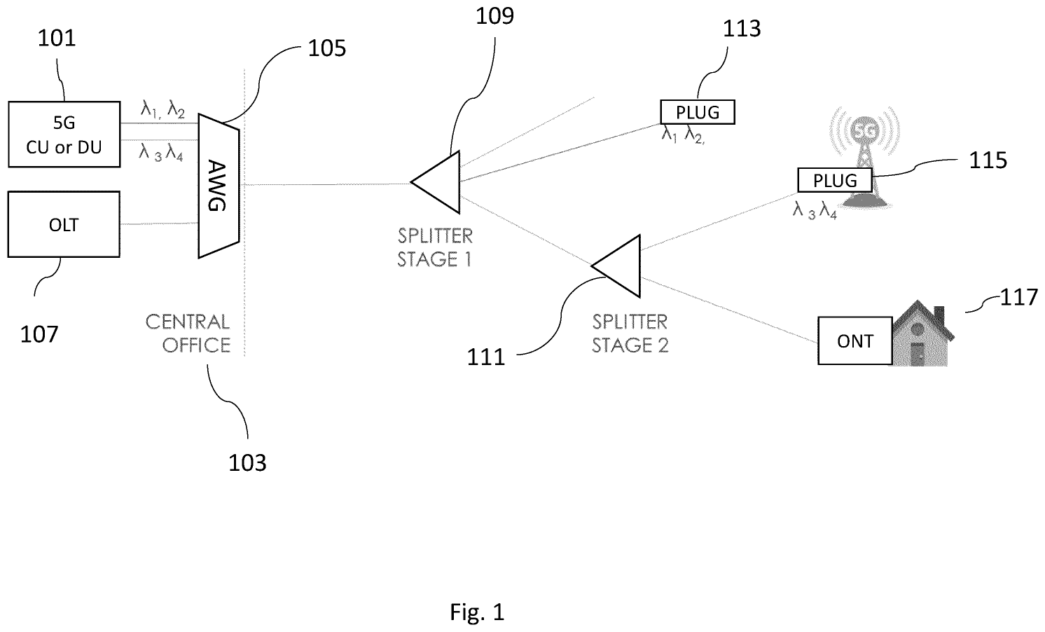

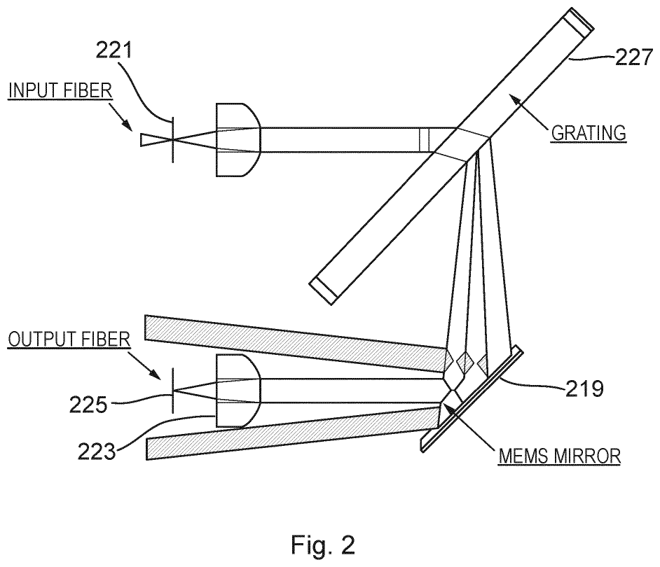

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

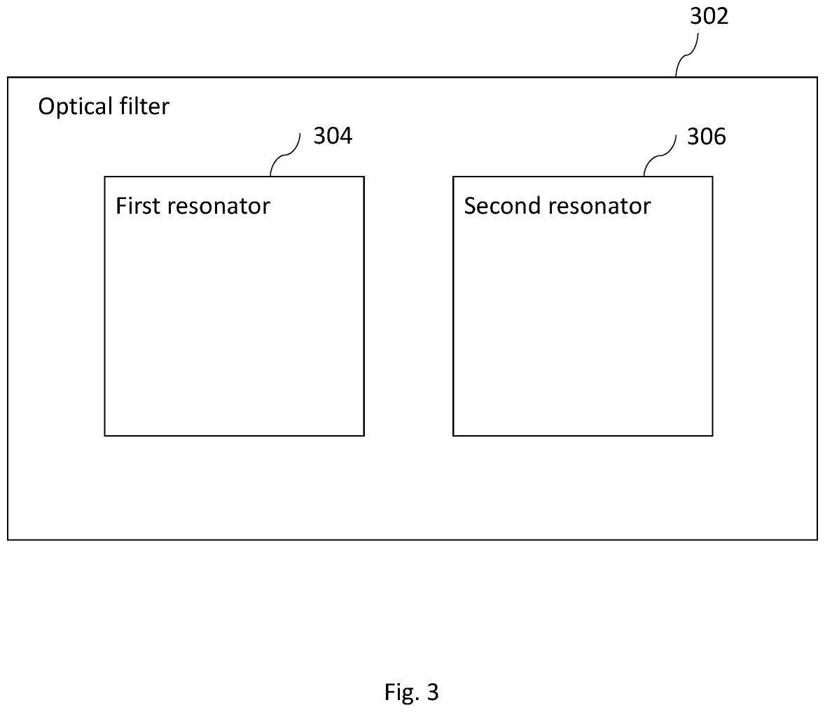

FIG. 3 illustrates an optical filter 302 comprising a first resonator 304 and a second resonator 306. The optical filter 302 may be implemented in an optical system, or used in an optical network, such as a wavelength-division multiplexing network (WDMN), coarse WDM (CWDM), dense WDM (DWDM) or any network topology within those classes such as ring, point-to-point, star, etc. The optical filter 302 is configured to receive an input signal (light) (for example, from the optical system or network) and output at least one output signal (for example, to the optical system or network). The optical filter may be configured to receive (or may be configured to determine) an indication of a target wavelength to be filtered by the optical filter (a wavelength to be added or dropped), e.g. from the optical system. The optical filter 302 is configured to adaptively add or remove (or drop) a target wavelength in a predetermined filter range (the target wavelength may be a wavelength included in the input signal). This may be achieved using the first resonator 304 and the second resonator 306.

The predetermined filter range may be a range of wavelengths which the optical filter is able to filter, and the range of values within the predetermined filter range may be set by the design of the optical filter (e.g. by the selection of particular materials, size and/or type of various components etc.). Each resonator may be configured to pass target wavelengths belonging to different sub-ranges of the predetermined filter range. The first resonator 304 is configured to have a first resonant wavelength outside a first sub-range of the predetermined filter range when a first resonance control variable of the first resonator is set at a first value, and a second resonant wavelength inside the first sub-range of the predetermined filter range when the first resonance control variable of the first resonator is set at a second value. Similarly, the second resonator 306 is configured to have a third resonant wavelength outside a second sub-range of the predetermined filter range when a second resonance control variable of the second resonator is set at a third value, and a fourth resonant wavelength inside the second sub-range of the predetermined filter range when the second resonance control variable of the second resonator is set at a fourth value. The sub-range is a range of wavelengths which is less than the filter range of the optical filter. In some examples, the wavelengths covered by the first and second sub-ranges are not overlapping, i.e. a different set of wavelengths. In some examples, the wavelengths covered by the first and second sub-ranges are contiguous. In some examples, the wavelengths covered by the first and second sub-ranges together provide the range of the optical filter. In some aspects, the first resonant wavelength is outside the first and the second sub-range. In some aspects, the third resonant wavelength is outside the first and the second sub-range. As such, the first and second resonator are configurable to pass a wavelength which is both within and outside of the range of the optical filter. Within the range of the optical filter, the first and second resonator may be operated in different (non-overlapping) sub-ranges.

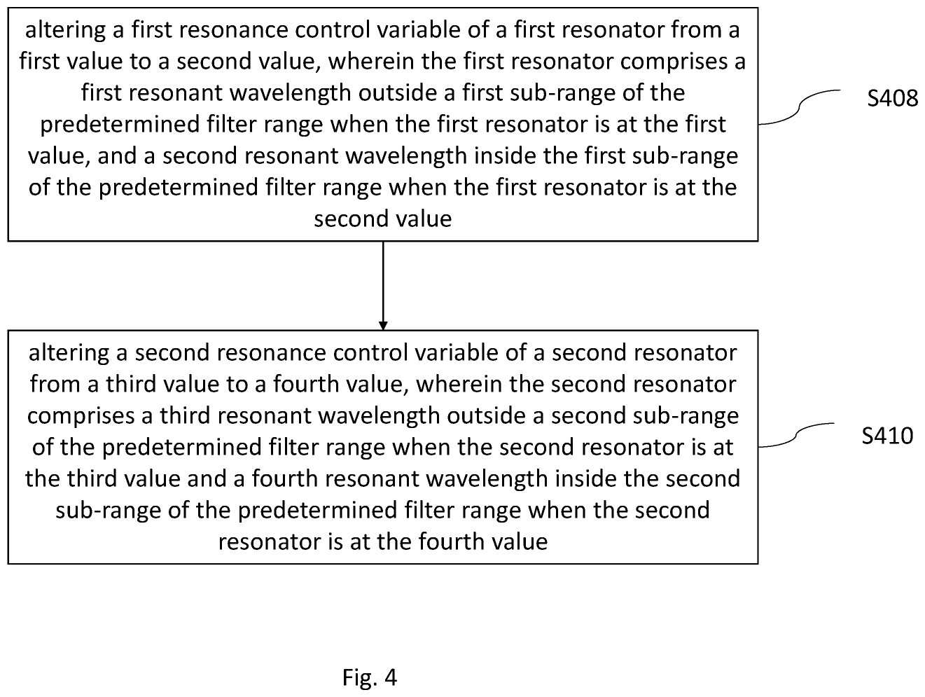

FIG. 4 illustrates a corresponding method of using an optical filter. In particular, FIG. 4 illustrates a method comprising altering a first resonance control variable of a first resonator from a first value to a second value, wherein the first resonator comprises a first resonant wavelength outside a first sub-range of the predetermined filter range when the first resonance control variable of the first resonator is at the first value, and a second resonant wavelength inside the first sub-range of the predetermined filter range when the first resonance control variable of the first resonator is at the second value (S408). The method further comprises altering a second resonance control variable of a second resonator from a third value to a fourth value, wherein the second resonator comprises a third resonant wavelength outside a second sub-range of the predetermined filter range when the second resonance control variable of the second resonator is at the third value and a fourth resonant wavelength inside the second sub-range of the predetermined filter range when the second resonance control variable of the second resonator is at the fourth value (S410).

Therefore, each of the resonators may be operated so that the resonant wavelength of each resonator may be moved in and out of the predetermined filter range. The first resonator may be operable over the first sub-range, and the second resonator may be operable over the second sub-range in normal use, so that each resonator is used to filter a different portion of the predetermined filter range (for example, normal use is when all resonators and the corresponding components are operable so that the resonant wavelength of the respective resonator can move into their respective sub-range).

The resonators may be configured so that in an “off”, or non-operating, configuration, where no power or heat is deliberately supplied to the resonators, the resonant wavelength of each resonator is outside of the predetermined filter range. If the input signal does not comprise the resonant wavelength of the resonators in the “off” configuration, no wavelengths will be filtered when the resonators are in the “off” configuration. Power or heat may be supplied to the resonators in order that their resonant wavelength is altered to a wavelength that is inside the predetermined filter range (in this case, the resonators will be in an “on” configuration). For example, the resonance control variable may be a voltage of an electrical gate of the resonator, and/or the resonance control variable may be the temperature of the resonator. It will be appreciated that either, or both of, these control variables may be used to control the resonant wavelength of either or both of the resonators.

This configuration of optical filter is particularly advantageous as only one resonator needs to be operated in order that the target wavelength is filtered. Each resonator may filter only a portion of the predetermined filter range, and therefore a resonator may be used to filter a target wavelength in their respective portion of the predetermined filter range. Furthermore, each of the resonators may define half, or substantially half, of the predetermined filter range. This means that the resonant wavelength of a resonator will not need to be altered as much, as the resonator with the resonant wavelength closest to the target wavelength may be operated, and therefore the resonant wavelength of either resonator is moved at a maximum over half of the predetermined filter range (rather than having one resonator which is moved over the whole predetermined filter range). Therefore, power consumption is saved. For example, where the resonant wavelength of a resonator is altered using the thermo-optic effect to alter the effective refractive index of the resonator (e.g. using local metal heaters), less power will be required to move each resonator over a portion of the predetermined filter range than would be required to move one resonator over the whole of the predetermined filter range.

The optical filter may be configured to selectively alter the first resonance control variable of the first resonator to the second value which is a value at which the second resonant wavelength corresponds to the target wavelength, or the second resonance control variable of the second resonator to the fourth value which is a value at which the fourth resonant wavelength corresponds to the target wavelength. Thus, either resonator may be selected depending on where the target wavelength is in the predetermined filter range (e.g., when the target wavelength is closest to the first resonant wavelength, the first resonance control variable of the first resonator may be altered, and when the target wavelength is closest to the third resonant wavelength, the second resonance control variable of the second resonator may be altered. Therefore, when the target wavelength is in the first sub-range the first resonator may be operated, and when the target wavelength is in the second sub-range, the second resonator may be operated).

While the resonators may operate over only a portion of the predetermined filter range during normal use, if one of the resonators is unable to filter a target wavelength which is in the sub-range which they would serve in normal use (for example, due to failure of a heating element, power supply, resonator etc. which may be detected by the optical system, the optical filter etc.), the other resonator may be operated so that its resonant wavelength can correspond to any target wavelength in the whole of the predetermined filter range, and therefore filter target wavelengths anywhere in the predetermined filter range (or can filter wavelengths in both their sub-range and the sub-range the other resonator would operate in in normal use). For example, the second resonator may be configured so that the second resonance control variable is alterable to a fifth value so as to generate a resonant wavelength in the first sub-range of the predetermined filter range if the first resonance control value cannot be altered from the first value to the second value (and vice versa). Therefore, the life of the optical filter may be prolonged as the optical filter will still be operable over the whole predetermined filter range even if one of the resonators is non-operable.

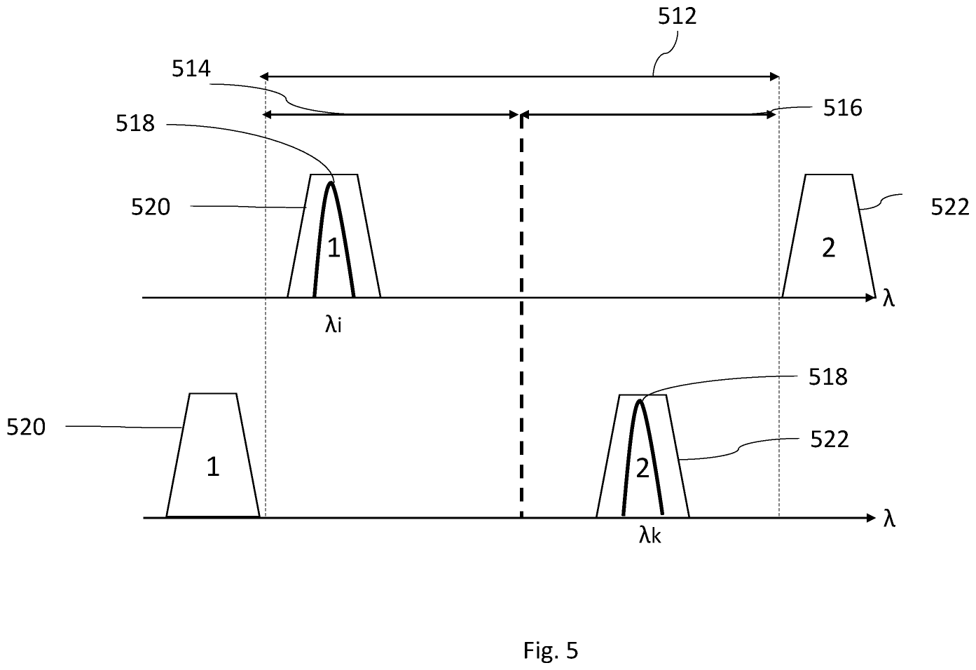

FIG. 5 comprises two graphs which illustrate, in the upper graph, the band pass of the two resonators when the first resonator (but not the second resonator) is operated, and in the lower graph, when the second resonator (but not the first resonator) is operated. FIG. 5 illustrates a predetermined filter range 512, which is divided into two sub ranges, a first sub-range 514 and a second sub range 516. In this example, the sub-ranges are each substantially half the predetermined filter range, and they do not overlap. Dividing the predetermined filter range into halves, or substantially halves, is advantageous as each resonator will use approximately the same amount of power to operate over their portion of the predetermined filter range. However, it will be appreciated that each resonator may be operable over different proportions of the predetermined filter range depending on the design.

As is illustrated in the upper graph of FIG. 5, the target wavelength 518 is in the first sub-range 514 of the predetermined filter range 512. In order to filter the target wavelength 518, the first resonator is operated (is in the “on” configuration) so that its resonant wavelength 520 moves into the first sub-range of the predetermined filter range to the target wavelength 518. The resonant wavelength 522 of the second resonator remains outside of the predetermined filter range 512 (the second resonator is in the “off” configuration). It will be appreciated that a resonator may comprise a passband including the resonant wavelength, where wavelengths within the passband will be filtered. Reference herein to movement of a resonant wavelength of a resonator may equally be interpreted as movement of a passband of a resonator. Wavelengths within the first sub-range are denoted by λd.

The alternative situation is illustrated in the lower graph of FIG. 5, where the target wavelength 518 is in the second sub-range 516 of the predetermined filter range 512. To filter the target wavelength 518, the second resonator is operated so that its resonant wavelength 522 moves into the second sub-range 516 of the predetermined filter range 512 to the target wavelength 518 (the second resonator is in the “on” configuration). The resonant wavelength 520 of the first resonator remains outside of the predetermined filter range (the first resonator is in the “off” configuration). Wavelengths within the first sub-range are denoted by λk.

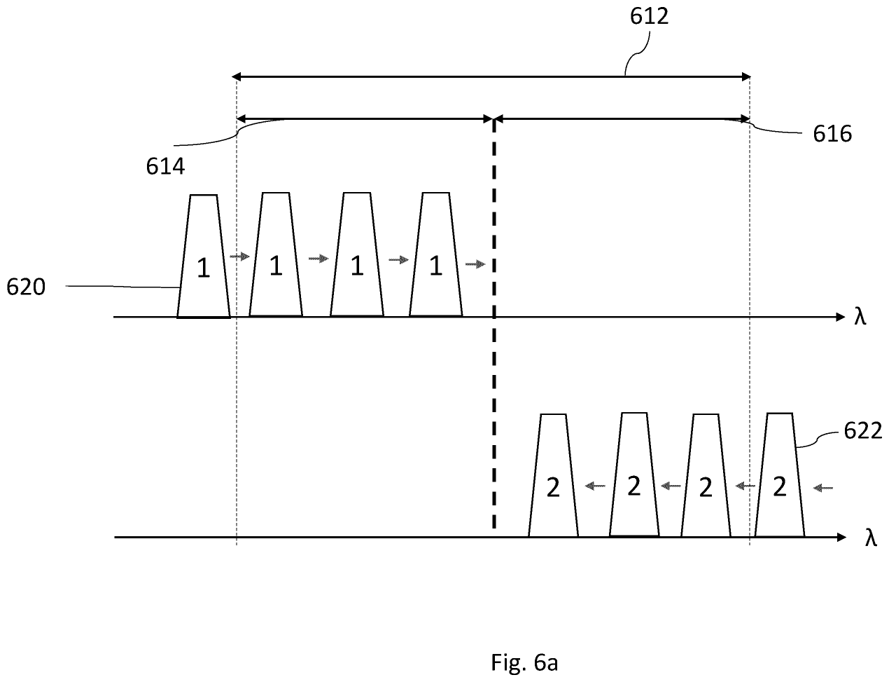

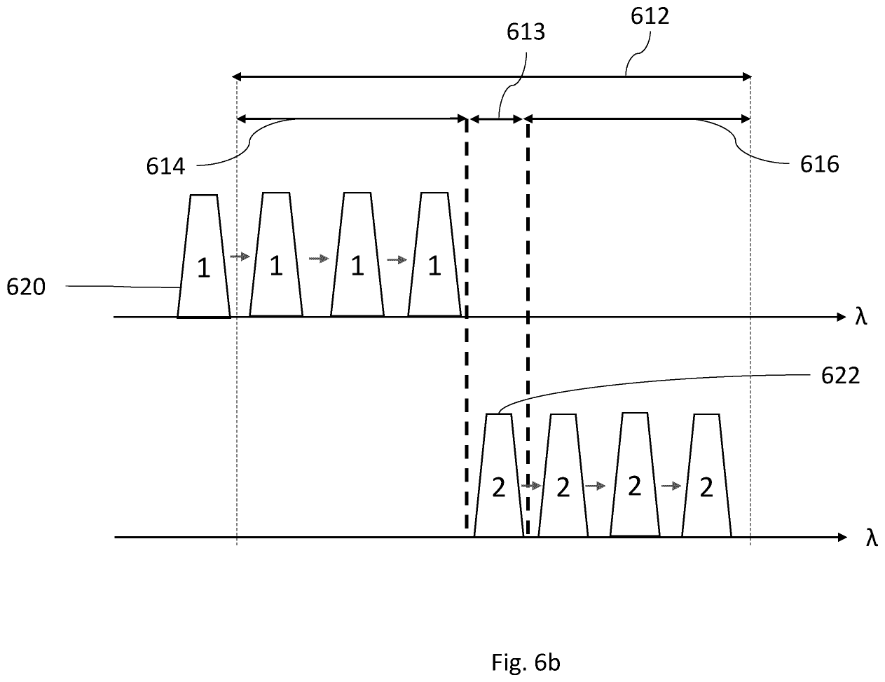

FIG. 6a-b illustrate the movement of resonant wavelengths from outside the predetermined filter range 612 to inside the predetermined filter range 612. The upper graph of FIG. 6a illustrates the movement of the resonant wavelength 620 of the first resonator from outside the predetermined filter range over the first sub-range 614 of the predetermined filter range The resonant wavelength of the first resonator is outside of the predetermined filter range when the first resonator is in an “off” configuration. In this example, the resonant wavelength of the first resonator is a wavelength that is shorter than a lower boundary of the predetermined filter range 612 when the first resonator is in an “off” configuration. When the first resonator is operated, the resonant wavelength of the first resonator increases and moves through the first sub-range of the predetermined filter range (an “on” configuration). The first resonator may therefore be operated to have a resonant wavelength at any wavelength within the first sub-range. The free spectral range (FSR) of the first resonator may be greater than the size of the predetermined filter range 612, where the free spectral range is the maximum spacing in wavelength (or equivalently in frequency) between two successive resonances of the resonator at a fixed control variable value. The fixed control variable value may be the control variable value when the resonator is in an “off” configuration. This may prevent more than one wavelength in the predetermined filter range from being filtered at the same time.

The lower graph of FIG. 6a illustrates the movement of the resonant wavelength 622 of the second resonator from outside the predetermined filter range 612 over the second sub-range 616 of the predetermined filter range. In this example, the resonant wavelength 622 of the second resonator is a wavelength that is longer than an upper boundary of the predetermined filter range 612 when the second resonator is in an “off” configuration. The resonant wavelength 622 of the second resonator is outside of the predetermined filter range 612 when the first resonator is in an “off” configuration. When the second resonator is operated (e.g. in an “on” configuration), the resonant wavelength of the second resonator decreases, and may move through the second sub-range 616. The free spectral range of the second resonator is greater than the size of the predetermined filter range 612, where the free spectral range is the maximum spacing in wavelength between two successive resonances of the resonator at a fixed control variable value. The movement of the resonant wavelength of the second resonator depicted in the lower graph of FIG. 6a may be suited for a case where the power consumption associated with the resonator control variable is at its lowest value when the resonant wavelength 622 of the second resonator is a wavelength that is longer than an upper boundary of the predetermined filter range 612. Therefore, where the power consumption is increased, the resonant wavelength decreases and the resonant wavelength 622 of the second resonator may move through the second sub-range 616 of the predetermined filter range 612.

FIG. 6b shows a variant for the movement of the resonant wavelength 622 of the second resonator. In this example, there is a guard band 613 provided within the predetermined filter range 612 between the first sub-range 614 and the second sub-range 616, in which the resonant wavelengths of the first or second resonators may be situated when the respective resonators are in an “off” configuration. The guard band may be considered to be a region excluded from the predetermined filter range 612. The upper graph of FIG. 6b illustrates the movement of the resonant wavelength 620 of the first resonator and is the same as that described in relation to FIG. 6a, where the first resonator is operable to move its resonant wavelength 620 over the first sub-range 614. The lower graph of FIG. 6b illustrates the movement of the resonant wavelength 622 of the second resonator from the guard band 613 over the second sub-range 616 of the predetermined filter range. In this example, the resonant wavelength 622 of the second resonator is a wavelength that is shorter than a lower boundary of the second sub-range 616 when the second resonator is in an “off” configuration. The resonant wavelength 622 of the second resonator is in the guard band 613 outside of the second sub-range 612 when the second resonator is in an “off” configuration. When the second resonator is operated, the resonant wavelength of the second resonator increases. The free spectral range of the second resonator is greater than the size of the predetermined filter range 612. The movement of the second resonator depicted in the lower graph of FIG. 6b may be suited to a case where the power consumption associated with the control variable is not at its lowest value when the resonant wavelength 622 of the second resonator is a wavelength that is shorter than a lower boundary of the predetermined filter range 612. For example, the power consumption associated with the control variable may be at its lowest value when the resonant wavelength 622 of the second resonator is a wavelength in the guard band 613.

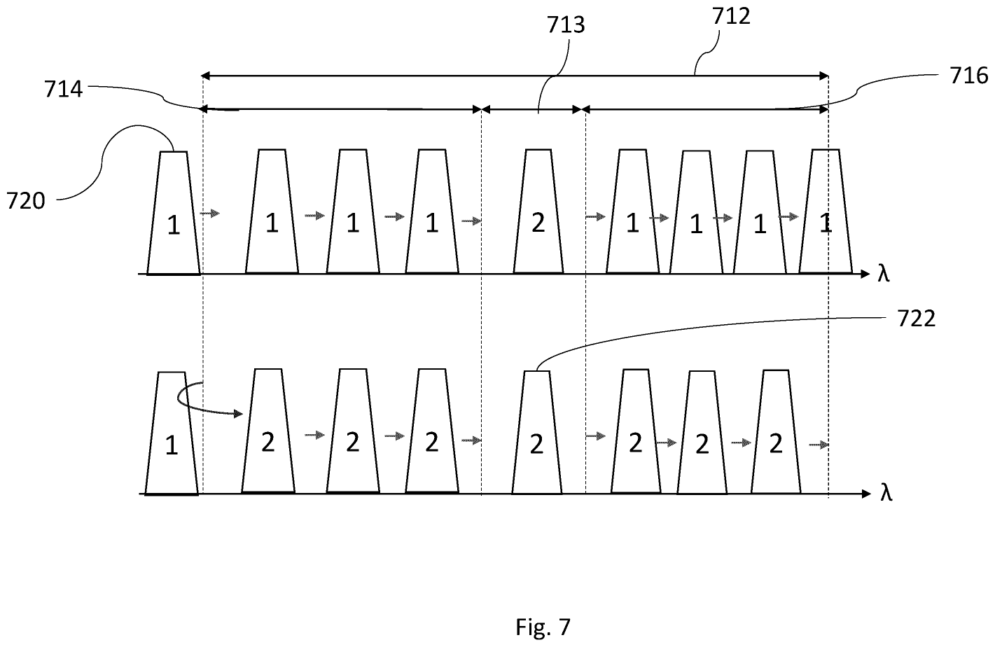

FIG. 7 illustrates a configuration where the resonators are configured so that the resonant wavelengths of the first and second filter may operate over the whole predetermined filter range 712. In this example, there is a guard band 713 provided within the predetermined filter range 712 between the first sub-range 714 and the second sub-range 716, in which the resonant wavelength of the second resonators is situated when the second resonator is in an “off” configuration. The resonant wavelength of the first resonator is situated below the lower boundary of the predetermined filter range when the first resonator is in an “off” configuration. Thus, in the ‘off’ position the resonance of the first resonator is at a wavelength smaller than the lower bound of the predetermined filter range 712. In the ‘off’ position the resonance of the second resonator is at a wavelength within the guard band 713. The guard band comprises a wavelength, or a set of wavelengths, that are not required to be filtered, or are unused. The predetermined filter range may be considered to exclude the guard band. In this example, the free spectral range of the resonant wavelengths of each of the first and second resonators are respectively the same size as, or greater than, the predetermined filter range 712. Therefore, in this configuration, both the first resonator and the second resonator are configured to be operable over the whole predetermined filter range.

In normal operation, the first resonator is configured to filter target wavelengths in the first sub-range 714 of the predetermined filter range 712, and the second resonator is configured to filter target wavelengths in the second sub-range 716 of the predetermined filter range 712. In this example, the first resonator is operated to filter target wavelengths in the first sub-range by initially increasing the resonant wavelength 720 through the first subrange 714 (e.g. to the target wavelength). The second resonator is operated to filter target wavelengths in the second sub-range 716 by increasing the resonant wavelength 722 so that the resonant wavelength of the second resonator moves through the second sub-range of the predetermined range (e.g to the target wavelength).

If one of the first and second resonator fails, the other of the first resonator and the second resonator are operable to filter target wavelengths over the whole predetermined filter range (target wavelengths in both the first sub-range and the second sub-range, e.g. they can also operate in the sub-range belonging to the failed resonator). The resonator may be considered to fail when it is not possible for the resonator to move the resonant wavelength into the sub-band which they are intended to serve in normal use. In this example, the first resonator can be operated to increase its resonant wavelength through the whole predetermined filter range 712 (from the first to sub-band through the second sub-band). The second resonator can be operated to increase its resonant wavelength 722 through the second sub-band until periodicity causes its resonant wavelength to move to the bottom of the first sub-band, and the resonant wavelength can then be increased through the first sub-band. Therefore, any target wavelength within the predetermined filter range can be filtered by the first and/or second resonator. In this configuration, in normal use, each of the resonators is only required to operate over half the range in which they are capable of operating, and therefore less power is required to operate the optical filter. However, if one of the resonators is unable to operate in their designated sub-range, the other resonator is able to operate to filter wavelengths in both sub-ranges (e.g. over the whole of the predetermined range), which prolongs the life of the optical filter in the case of failure of a part of the optical filter.

It is noted that for the configuration of FIG. 6a, in case of failure the first resonator can be operated to increase its resonant wavelength through the whole predetermined filter range 712, and the second resonator can be operated to reduce its resonant wavelength through the whole filter range, depending on the requirements.

It is noted that both or either of the resonators may be configured as described above. For example, either or both resonator may have a resonant wavelength in the guard band, and/or either or both resonator may have a resonant wavelength outside of the upper and/or lower bands of the predetermined filter range, when the resonators are in an “off” configuration. The resonators may have a resonant wavelength above or below the upper and lower bands of the predetermined filter range respectively, or a resonant wavelength in the guard band, when the resonator is consuming a minimum amount of power or heat.

Various resonators may be used in the invention defined by the present claims. One such type of resonator is a ring resonator (e.g. a Micro Ring Resonator (MMR), optical ring resonator).

The optical path length difference (OPD) of a ring resonator may be give as:

OPD=2πrn_{eff} (1)

where r is the radius of the ring resonator and n_{eff} is the effective index of refraction of the waveguide material and depends on the optical properties of its guiding materials. For resonance to take place, the following condition must be satisfied:

ODP=mλᵣₑₛ (2)

where λᵣₑₛ is the resonant wavelength and m is the mode number of the ring resonator. For light to constructively interfere inside the ring resonator the circumference of the ring must be an integer multiple of the wavelength of the light. Thus, when light incident on the ring resonator contains multiple wavelengths, only resonant wavelengths pass through the ring resonator fully.

Each ring resonator is characterized by a set of resonant frequencies λᵣₑₛ spaced by the free spectral range (FSR), the distance between two adjacent resonances. For ring resonators, the value of the resonant frequency is related to the size (circumference) to L of the ring by the following:

$${λ}_{res} = \frac{{n}_{eff} L}{m} \qquad ( 3 )$$

where n_{eff} is the effective refractive index and m is the mode number of the ring resonator. The free spectral range for a given λ is

$$FSR = \frac{{λ}^{2}}{{n}_{g} L} \qquad ( 4 )$$

where n_{g} is the group index. Thus, a given wavelength resonance value can be achieved with different L values, whereas for a given value of λ the FSR is strongly dependent on the size of the ring and its material/design. The size of the ring and the materials or its design may be selected in order that the ring resonator has an appropriate value of λᵣₑₛ and FSR (in particular considering the requirements of the predetermined filter range specified above). The predetermined range may be achieved by the design of the resonators, where the resonators are designed (using certain dimensions, material, etc.) to allow them to have a resonant wavelength outside the predetermined filter range when no heat or power is supplied to the resonator, but also to be operable to have a resonant wavelength inside (over the whole) the predetermined filter range when heat or power is supplied to the resonator.

The operating range for a ring-based resonator corresponds to its spectral range. The two resonators that constitute the filter may have almost the same FSR, and may provide a band width (BW) that is e.g. at least 20 nm for application in WDM networks (with a pre-selection of the DL, UL bands).

The FSR may have a minimal variation ΔFSR over the range of wavelengths over which the optical filter will operate:

$$Δ FSR = \frac{2 λΔλ}{{n}_{g} L} \qquad ( 5 )$$

(that is about 1 nm for a reference wavelength of 1530 nm and 20 nm variation, assuming the case of standard silicon photonic waveguides for optical properties (the ring radius is about 4.5 um for this set of parameters)). This difference may be considered in the design, allowing the necessary margin so that the FSR is larger than the predetermined filter range.

The two resonators may be tuned to have a resonant wavelength that is out of the predetermined filter range when they are not in operation. To allow this the FSR may be larger than the operating range (predetermined filter range) to allow the resonator to be placed out of resonance at both the upper and lower boundaries of the predetermined filter range.

To allow operation in a different portion of the spectrum, there may be a slight difference (20 nm for the parameters considered above) in the radius of the two resonators, that will imply that one resonator (the one with smaller radius) will have a larger FSR, that is 1 nm larger than the other, for the case considered above. However, the first and second resonator may still be configured so that the FSR of each resonator is larger than of the predetermined filter range considering the difference in FSR, so that in an “off” configuration, the resonant wavelengths of each resonator are outside of the predetermined filter range.

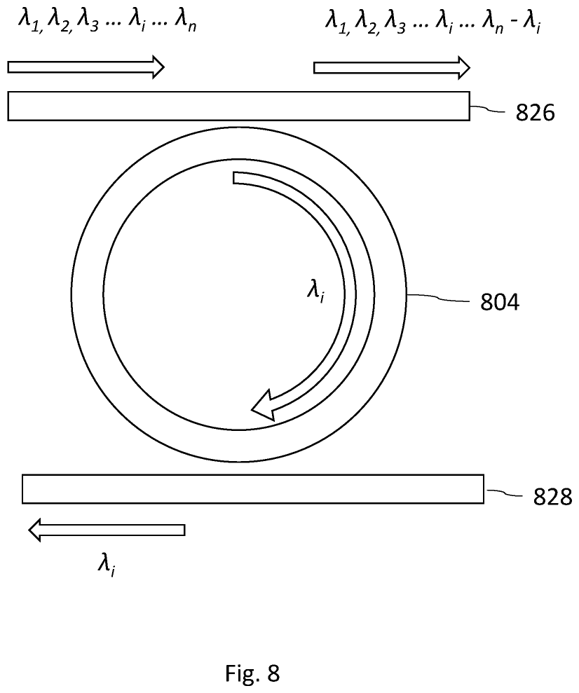

An example of such a ring resonator is illustrated in FIG. 8. FIG. 8 illustrates a ring resonator 804 which is optically coupled to a first wave guide 826 (an input or throughput waveguide, bus waveguide, through which signals propagate), and is also coupled to a second wave guide 828 (an output or drop waveguide). A beam of light (a signal) passes through the first waveguide 826, where the beam of light comprises a plurality of wavelengths (λ₁, λ₂, λ₃ . . . λᵢ . . . λₙ). The light is coupled into the ring resonator 804, and the wavelength of light which is the resonant wavelength λᵢ of the ring resonator constructively interferes in the ring resonator 804 (the signal comprises the resonant wavelength). In this example, the resonant wavelength couples to the first wave guide 826 and cancels the wavelength λᵢ, so that the throughput light does not comprise the resonant wavelength λᵢ. This may be used to filter out specific wavelength (e.g. channel) of light, where light of other wavelengths are let through the first wave guide 826. Light of the resonant wavelength λᵢ of the resonator 804 is also coupled into the second wave guide 828. Therefore, light of the resonant wavelength λᵢ may be coupled out of the resonator. This configuration provides a function in the first wave guide 826 where the resonant wavelength of the resonator 804 will be removed from the throughput, and a function in the second waveguide 828 where the resonant wavelength of the resonator 804 can be extracted. It will be appreciated that the optical filter may comprise one or both outputs of the described first and second waveguides, depending on whether wavelengths are to be added or removed.

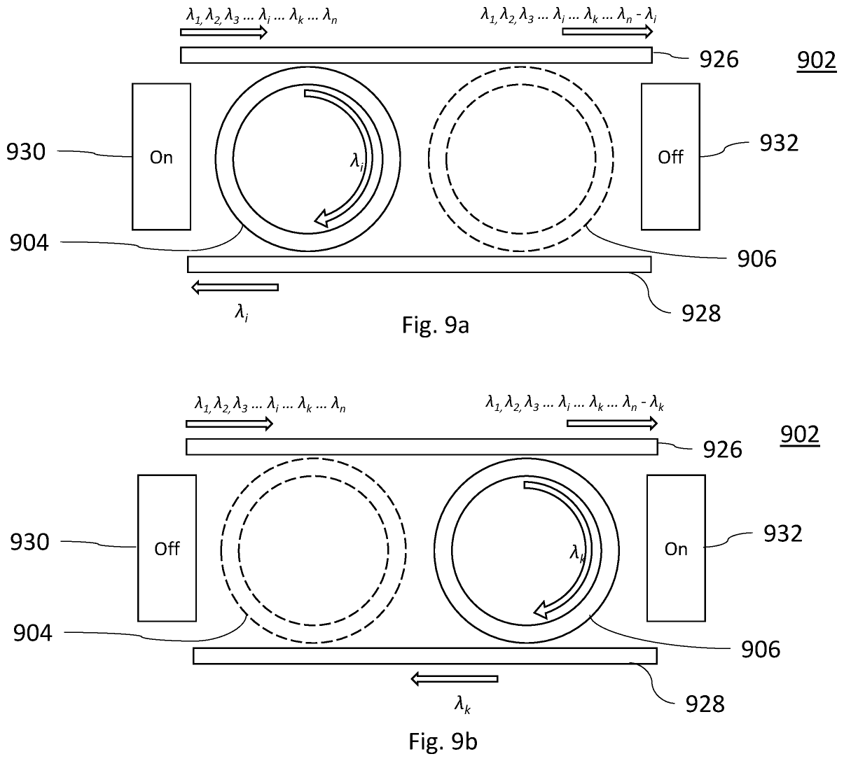

FIG. 9 illustrates an optical filter comprising a first resonator 904 and a second resonator 1106 in the configuration described in relation to FIG. 8 above. Where both resonators are in an “off” state, the resonant wavelengths of the resonators are outside of the predetermined filter range (they may be in the guard band). Each resonator is configured to resonate at a different wavelength when in an “off” configuration. The resonators are therefore designed (formed) to have particular resonant wavelengths that differ from one another in an “off” configuration. In this example, the radius of the first resonator and the second resonator are different, thereby giving each resonator a different resonant wavelength in the “off” configuration. The radius of the first resonator may be greater or smaller than the second resonator and vice versa.

The optical filter may be operable to control the movement of the resonant wavelengths of the first and second resonators as described in relation to FIGS. 5-7, where the resonators are configured so that, in normal use, the first resonator is operable at resonant wavelengths inside a first sub-range of a predetermined filter range of the optical filter, and the second resonator is operable at resonant wavelengths λₖ inside a second sub-range of the predetermined filter range.

In this example, the optical filter 902 also comprises a first controller 930 for altering a control variable of the first resonator 904 and a second controller 932 for altering a control variable of the second resonator 906. The first controller 930 may be operable to alter a first resonance control variable of the first resonator 904. For example, the first controller may be operable to alter a first resonance control variable of the first resonator 904 from a first value to a second value. The first value may be a value at which a first resonant wavelength of the first resonator is outside the first sub-range of the predetermined filter range. The second value may be a value at which a second resonant wavelength of the first resonator is inside the first sub-range of the predetermined filter range. The second controller 932 may be operable to alter a second resonance control variable of the second resonator 906 from a third value to a fourth value. The third value may be a value at which a third resonant wavelength of the second resonator is outside a second sub-range of the predetermined filter range. The fourth value may be a value at which a fourth resonant wavelength of the second resonator is inside a second sub-range of the predetermined filter range.

The first controller 930 and the second controller 932 may therefore be operable to alter the resonant wavelength of the first resonator 904 and the second resonator 906 respectively so that the resonant wavelengths of the resonators can be moved into, and out of, the predetermined filter range as required, and therefore used to filter wavelengths. The controllers may receive an indication of a target wavelength to be filtered by the optical filter (for example, a signal may be received from an optical system indicating the target wavelength to be filtered), and may operate to alter the resonant wavelength of the appropriate resonator. It is noted that one controller may be used to alter the resonant wavelength of the first resonator and the second resonator.

This Figure illustrates, in FIG. 9 (a), a scenario where the first controller is in an “on” configuration, and is operated to cause the resonant wavelength of the first resonator to move into the first sub-range of the predetermined filter range. The second controller is in an “off” configuration, and therefore the resonant wavelength of the second resonator is outside of the second sub-range of the predetermined filter range. Thus, the resonant wavelength λᵢ of the first resonator is removed from the first waveguide 926 and added into the second waveguide 928.

FIG. 9(b) illustrates the alternative scenario, where the first controller is in an “off” configuration, and therefore the resonant wavelength of the first resonator is outside of the first sub-range of the predetermined filter range. The second controller is in an “on” configuration, and is operable to cause the resonant wavelength of the second resonator to move into the second sub-range of the predetermined filter range. Thus, to the resonant wavelength λₖ of the first resonator is removed from the first waveguide 926 and added into the second waveguide 928.

The respective controllers may be operable to cause the first and second resonators to have any resonant wavelength within the predetermined filter range. The optical filter may therefore be configured to select a single resonant frequency (wavelength) in the predetermined filter range, adding/removing just a specific channel. The controllers may receive an indication of a target wavelength to be filtered (e.g. added or removed). The controllers may receive instructions on whether the resonant wavelength of their respective resonator is to be altered (or the controllers themselves may determine whether their respective resonator is to be altered based on the target wavelength and whether it is in the relevant portion of the predetermined filter range). Where the target wavelength is in the first sub-range, the first controller may alter a first resonance control variable to alter the resonant wavelength of the first resonator, and when the target wavelength is in the second sub-range, the second controller may alter a second resonance control variable to alter the resonant wavelength of the second resonator.

One method of altering the resonant wavelength of the optical resonator is to change the effective refractive index of the material forming the resonator. This may be achieved by heating the resonator. For example, a heating element may be used to heat the resonator to a temperature at which the effective refractive index corresponds to the desired resonant wavelength.

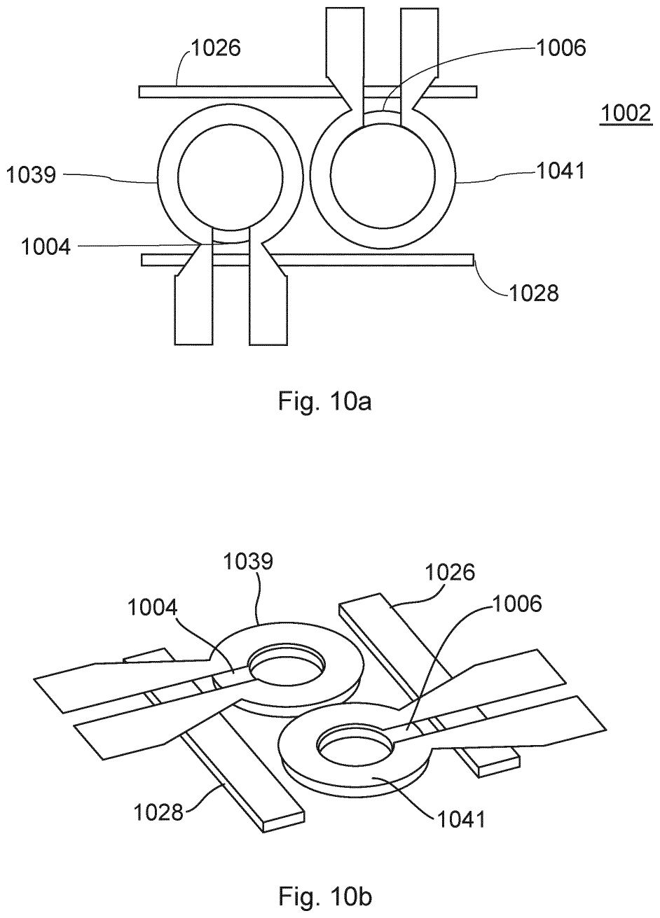

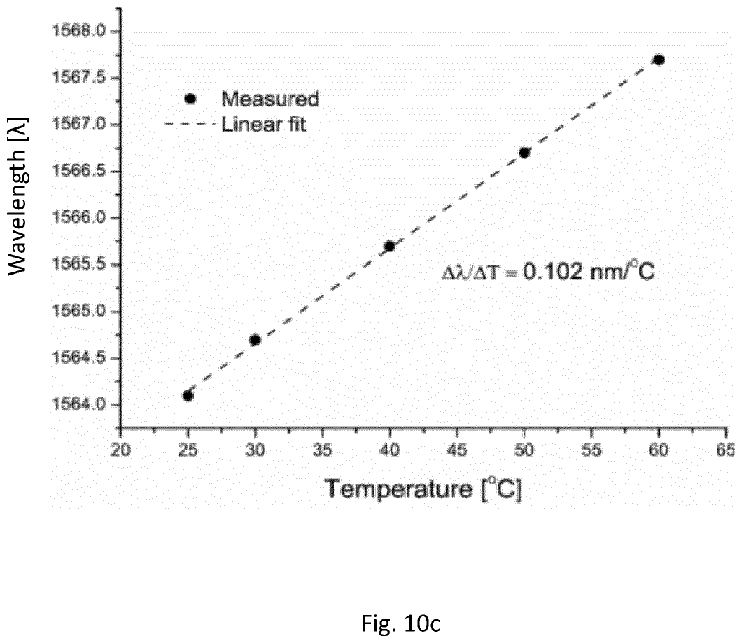

FIG. 10a illustrates an optical filter comprising a first heater 1039 and a second heater 1041. (FIG. 10b illustrates a 3D version of the optical filter of FIG. 10a.) The optical filter of FIG. 10a is arranged similarly to that of FIG. 9, where a first ring resonator 1004 and a second ring resonator 1006 are provided, and are proximal to a first waveguide 1026 and a second waveguide 1028. As is shown in this Figure, the first heater 1039 and the second heater 1041 are located adjacent to the first resonator 1004 and the second resonator 1006 respectively. Each heater may be independently operated, so that each of the first resonator 1004 and the second resonator 1006 can be individually heated. The first and second controller are not shown in this Figure, however, it will be appreciated that the first controller and the second controller may each comprise (or be connected to) a respective heater (or heating element). Alternatively, in any of the examples described herein, a single controller may be connected to both heaters, and be operable to control both heaters. A controller may be operated to cause their respective heater to be heated (e.g. by supplying a current, power) to a temperature which causes the resonator with which the respective controller is associated to also be heated. As the resonator is heated, its effective refractive index also changes. This leads to a change in resonant wavelength. The effect of an increase in temperature of a resonator (ring resonator) on the resonant wavelength of a ring resonator is outlined in the example illustrated in FIG. 10c. The ring resonator of FIG. 10c has a 10 um diameter, as an example. As is shown in FIG. 10c, there is a linear relationship between an increase in temperature and an increase in resonant wavelength of a ring resonator. Therefore, using this correlation, it is possible to select a temperature to which a heating element is heated in order to heat the resonator to a temperature which corresponds to the target wavelength, in order to filter a target wavelength as described in relation to the examples herein.

Materials such as silicon (Si) may be particularly advantageous in forming a ring resonator with a particular resonant wavelength as they allow high fabrication precision and the ability to have control of the effective refractive index of the composite structure, which is determined by the fabrication process. Using materials such as Si to form the optical filter, it may also be possible to achieve fine tuning of the effective refractive index of the resonator via heating of the resonator area, exploiting the thermo-optic effect (the change in optical properties due to temperature variations (e.g. the thermo-optic coefficient for Si is

$$\frac{db}{dT} = 1.8 \times {10}^{- 4} {K}^{- 1}$$

(around 300K))). The tunability of resonators is particularly relevant in WDM filtering applications where a transmission channel, carried by a selected wavelength (e.g. a target wavelength), has to be added or removed at a given port.

Thus, it may be possible to reconfigure the add/remove scheme in a deployed network by a change in the electric current that feeds the heating elements of the resonators. One method for heating ring resonators in silicon photonic circuits is via resistors made of thin films that dissipate heat locally via Joule heating.

The optical filters described herein may enable an increase in the life of the metallic elements that operate the tuning operation on the resonators of the optical filter (for example, heating elements). This may be of the order of 10 years for a tunable transceiver, but thermal induced stress can induce premature ageing of the material and failure. Thus, the life of a heating element may be increased of a factor 10 or more depending on the implementation.

It is advantageous to have heating elements which exhibit high thermal stability so that they can withstand elevated temperatures. However, even very stable compounds such as Ti\TiN films exhibit a change in their characteristic resistance as a function of the operating temperature (12% from 25 to 350° C. in Ti\TiN films) and may undergo premature failure if operating at temperatures as high as e.g. 300° C. for long periods of time (changes in the resistance may be addressed with calibration). The advantage of the configuration is that each heating elements does not need to be heated to as high a temperature as they do not need to operate over a whole predetermined filter range. Therefore, the life of the heating elements may be prolonged. The materials for formation of the heating elements may be chosen in conjunction with consideration of the temperature increase needed in order to alter the resonant wavelength to necessary wavelengths.

A temperature variation of 100° C. may be necessary for a tuning range of 10 nm of the resonant wavelength of a resonator. However, due to the low thermal conductivity (1.38 W/m K) of typical cladding materials that may separate the heating elements from the ring waveguide, the temperature experienced by the resistors in the tuning process where the resonant wavelengths of the resonators are altered may be much higher than the temperature experienced by the resonator. Additionally, there may be hot spots in the resistors that reach higher temperature than average. Calibration may therefore be required to ensure correspondence of the temperature of a heating elements and movement of the resonant wavelength.

To predict the lifetime of the Ti/TN resistors, the following thermal model based on the Arrenhius equation may be used:

$$MTTF = A exp ( \frac{{E}_{a}}{kT} ) \qquad ( 6 )$$

where MTTF is the median-time-to-failure, k is Boltzmann's constant, T is the temperature, Eₐ is the thermal activation energy, and A is a constant. Using this equation, it is evident that a reduction of the temperature of a factor 2 increases the lifetime of the resistor by a factor 8.

Therefore, it is beneficial to limit the operational temperature of metallic heaters formed from the aforementioned materials to below 300° C. in order to provide a longer lifetime for the optical filter.

By providing an optical filter with two resonators configured so that a first resonator is tuned by a first set of heaters and second resonator is tuned by a second set of heaters, the first resonant structure can be tuned to operate add/remove a channel with carrier wavelength in a first half (or first sub-range) of the predetermined filter range of the optical filter and the second resonant structure can be tuned to operate add/remove a channel with carrier wavelength in a second half (or second sub-range) of the predetermined filter range. A further advantage is that, by using a resonator on a reduced portion of the predetermined filter range (e.g. the operating range) of the filter, i.e. the portion that contains the wavelength to be added/removed, the power consumption is reduced. The required power decreases linearly with the resonant shift required for tuning when heaters are used to heat the resonators. The resonators' resonant wavelengths are set out of the predetermined filter range by design and the heaters may shift the resonance of one resonator to the selected wavelength.

Thus, a composite tunable integrated resonant element capable of operating a wavelength filtering operation or an add/remove operation from/to a channel waveguide to a bus waveguide may be provided in a way that may increase the efficiency of the tuning operation, save power and guarantee its robustness against ageing and performance loss of the tuning apparatus, since it may operate at lower temperatures.

Any method which alters the resonant wavelength of a resonator (e.g. by changing the effective refractive index of the material from which the resonator is constructed) may be used to alter the resonant wavelength of a resonator. For example, an alternative way in which the resonant wavelength of a resonator may be altered is to change the voltage of an electrical gate of the resonator (e.g. from no voltage to a voltage). Thus, the resonance control variable may be a voltage. This may be achieved by e.g. exploiting the carrier dispersion effect. Carrier dispersion effect can alter the effective refractive index of the material from which the resonator is constructed by altering the carrier concentration in the material. This can be achieved e.g. in ring resonators made of doped silicon, with P-type and N-Type Silicon to form a PN junction; in this configuration the control variable may be a bias voltage between the P and N region, applied through metal contacts. Thus, the voltage may be altered to alter the resonant wavelength of the resonator.

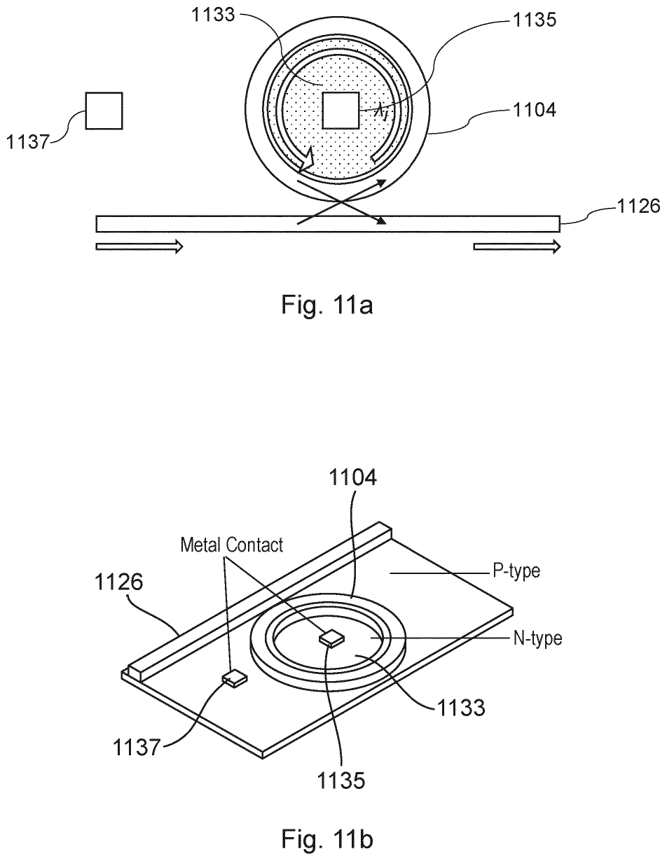

This configuration is illustrated in FIG. 11a, in which a ring resonator 1104 is formed from P-type material as the ring, where the portion 1133 inside the ring is formed from N-type material. A first metal contact 1135 is provided at the portion 1133 inside the ring, and a second metal contact 1137 is provided outside the ring, in a P-type region. A bias voltage may be applied between the two regions via the metal contacts. The waveguide 11 is also formed from P-type material, and may function as any of the other waveguides described above. FIG. 11b illustrates a 3D view of this configuration.

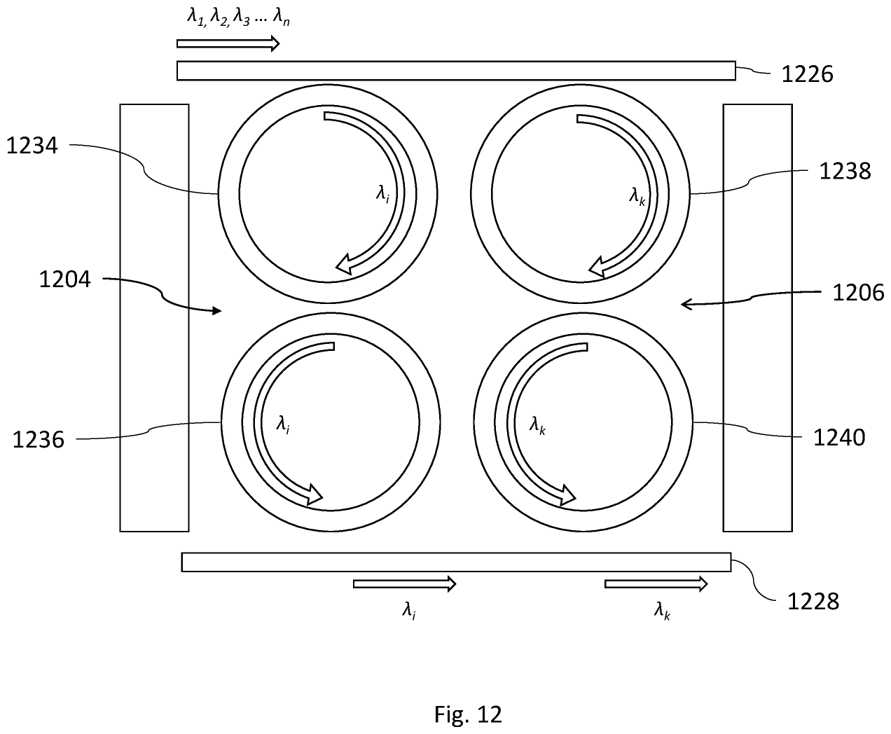

FIG. 12 illustrates a further configuration of an optical filter comprising ring resonators as the first resonator 1204 and the second resonator 1206. This example is similar to the optical filter shown in FIG. 9, however, in this example, the first resonator 1204 comprises a first and a second ring resonator 1234, 1236, and the second resonator comprises a third and a fourth resonator ring resonator 1238, 1240. Light couples from a first wave guide 1226 into the first ring resonator 1234, the light then couples from the first ring resonator into the second ring resonator 1236, and then the light couples from the second ring resonator into the second waveguide 1228.

Similarly, in this example, the second resonator 1206 comprises a third and a fourth ring resonator 1238, 1240, where light couples from the first wave guide 1226 into the third ring resonator 1238, the light then couples from the third ring resonator into the fourth ring resonator 1240, and then the light couples from the fourth ring resonator into the second waveguide 1228.

In this example, the first and second ring resonators have the same resonant wavelength when in an “off” configuration, and the first resonator being operated so that the resonant wavelength of the resonator moves involves heating both the first and second ring resonators to the same temperature (or altering the resonance control value to the same value for both ring resonators), so that they both have the same resonant wavelength. The third and fourth ring resonators are similarly configured to have the same resonant wavelength as one another, the second resonator being operated so that the resonant wavelength of the resonator moves involves heating both the first and second ring resonators to the same temperature (or altering the resonance control value to the same value for both ring resonators), so that they both have the same resonant wavelength. The same controller or separate controllers may be used for ring resonators in the same resonator. Similarly, the same heating element or separate heating elements may be used for ring resonators in the same resonator. The first and second resonators may have different resonant wavelengths or the same resonant wavelengths in the “off” configuration.

It will be appreciated that this may be extended so that each resonator comprises a plurality of ring resonators (e,g, 1, 2, 3, 4 . . . etc). Ring resonators within the same resonator may maintain the same resonant wavelength, both in their “off” configuration and in their “on” configuration.

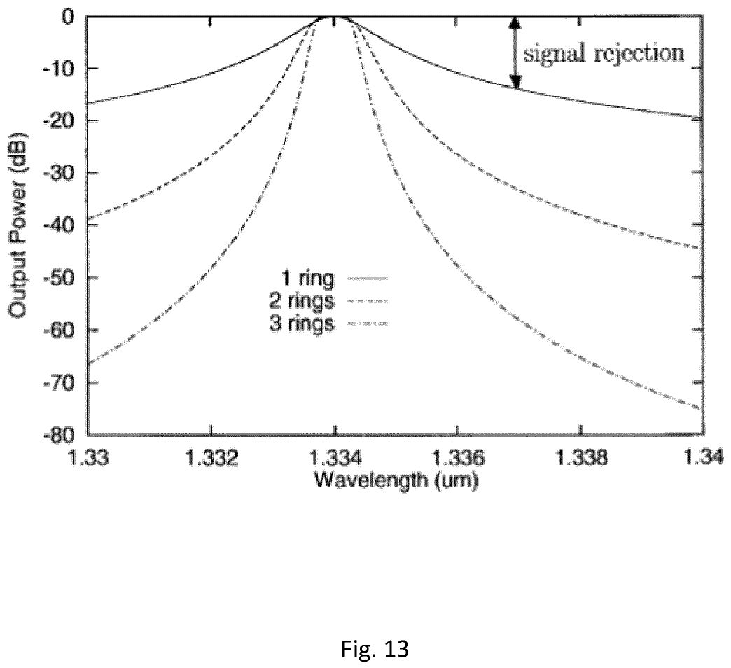

The effect of using multiple ring resonators in the configuration of FIG. 12 is illustrated in the graph shown in FIG. 13, which illustrates the filter profile for a resonator comprising one ring, two rings and three rings. The shape of the filter profile and its optimal coupling may be determined by the width of the separation between the bus waveguide and the ring, and the gap between the two rings, together with the waveguide characteristics. As can be seen from this graph, using two or more coupled ring resonators for the resonator provides a flatter filter response with a sharper profile which is particularly useful in reducing inter-channel crosstalk.

An alternative type of resonator which may be used in the optical filter to filter wavelengths is a Bragg resonator (a Bragg reflector, a distributed feedback Bragg reflector). Distributed Feedback Bragg Resonators are multi-cavity optical filters using integrated standing-wave resonators that use Bragg gratings to reflect radiation at the resonant wavelength. The grating consists of a waveguide with periodic corrugations, which exist in different shapes, and have a pitch corresponding to a quarter of wavelength of the resonant wavelength. These grating are used as reflectors of an optical cavity or a set of coupled optical cavity whose output is radiation with a spectrum that is characterized by a set of regularly spaced resonances, with spacing A given by the reverse of the optical path of radiation in the cavity

$$A = \frac{1}{2 {n}_{eff} L} . \qquad ( 7 )$$

A Bragg resonator will therefore reflect a resonant wavelength of the resonator, and allow other wavelengths to pass. As with the ring resonators above, the resonant wavelength of the Bragg resonator by altering the effective refractive index of the cavity of the Bragg resonator. By heating the Bragg resonator, the effective refractive index, and therefore the resonant wavelength, may be altered. The Bragg resonator may therefore be used similarly to the ring resonators described above, where an optical filter may be configured to add or remove resonant wavelengths (or both, or either) in an optical system. In this example, heating of the resonator is described to alter the resonant wavelength, however, any appropriate method which alters the resonant wavelength, such as by altering the effective refractive index, may be implemented.

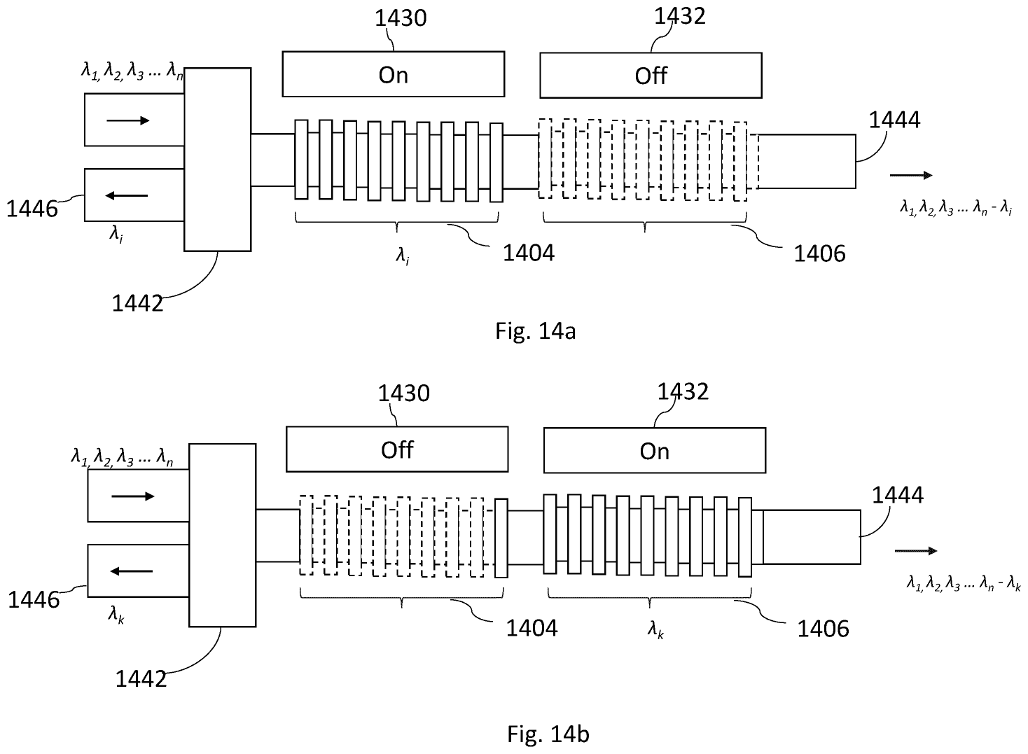

An example of an optical filter comprising such a resonator is illustrated in to FIG. 14. In FIG. 14, a first resonator 1404 (a Bragg resonator) and a second resonator 1406 (a Bragg resonator) are illustrated. The first resonator 1404 and the second resonator 1406 may be connected to a Multi Mode Interferometer (MMI) 1442 which is configured to send an input signal from an input waveguide to the resonators and is configured to send the reflected radiation to a drop port 1446 (e.g. an output waveguide). Non resonant wavelengths (e.g. non-reflected wavelengths) proceed through the first resonator 1404 and the second resonator 1406 to a through port (an output/throughput waveguide) 1444.

As is described in relation to the other examples above, the first resonator is configured to have a resonant wavelength outside a first sub-range of a predetermined filter range when a first resonance control variable of the first resonator is set at a first value, and a second resonant wavelength inside the first sub-range of the predetermined filter range when the first resonance control variable of the first resonator is set at a second value. The second resonator is configured to have a third resonant wavelength outside a second sub-range of the predetermined filter range when a second resonance control variable of the second resonator is set at a third value, and a fourth resonant wavelength inside the second sub-range of the predetermined filter range when the second resonance control variable of the second resonator is set at a fourth value.

Thus, the resonators may be used to filter target wavelengths in the sub-ranges of the predetermined filter range as is described in relation to the examples above. As is described above, the resonant wavelengths of the Bragg resonators may be altered by altering the temperature of the first and second resonators. The resonant wavelengths of the Bragg resonators may be altered by a first controller 1430 and a second controller 1432. The first and second controllers may comprise heating elements which are used to alter the temperature of their respective resonator in the same manner as is described in relation to the examples above.

Thus, as is described above in relation to the other examples, a signal may be input to the optical filter, where a target wavelength may be filtered either by the first resonator or the second resonator by altering the resonant wavelength of the relevant resonator, where the first resonator and the second resonator operate in normal use over the first sub-range or the second sub-range respectively. The optical filter comprising the Bragg resonators may also be configured to operate over the whole predetermined filter range even if one resonator is not operable over their sub-range, as is described in relation to the other examples herein.

FIG. 14a) illustrates a configuration where the first resonator 1404 is in an “on” configuration (for example, is heated) and the second resonator 1432 is in an “off” configuration. In particular, where the target wavelength to be filtered is in the first sub-range of the predetermined filter range, the first controller 1430 may be operated to cause the resonant wavelength of the first resonator to move to the target wavelength (e.g. by heating the first resonator). As is illustrated in this example, the first resonator is configured to reflect the resonant wavelength λᵢ, which is output by the MMI to an output waveguide. The resonant wavelength does not pass through the first resonator, and therefore, the signal which is transmitted through the throughport 1444 (e.g. an output waveguide) does not contain the resonant wavelength. The resonant wavelength is reflected by the resonator, and the resonant wavelength is therefore transmitted through the drop port 1446. Thus, the resonant wavelength can be added or removed in an optical system connected to the optical filter.

Similarly, FIG. 14b) illustrates the alternative situation in which the first resonator 1404 is in an “off” configuration, and the second resonator 1406 is in an “on” configuration. In particular, where the target wavelength to be filtered is in the second sub-range of the predetermined filter range, the second controller 1432 may be operated to cause the resonant wavelength of the second resonator to move to the target wavelength (e.g. by heating the second resonator). As is illustrated in this example, the second resonator is configured to reflect the resonant wavelength λₖ which is output by the MMI 1442 to an output waveguide. The resonant wavelength does not pass through the second resonator, and therefore, the signal which is transmitted through the through port 1444 does not contain the resonant wavelength. The resonant wavelength is reflected by the resonator, and the resonant wavelength is therefore transmitted through the drop port 1446. Thus, the resonant wavelength can be added or removed in an optical system connected to the optical filter.

The optical filter comprising the Bragg resonators may also be configured so that each of the Bragg resonators can operate over the sub-range of the other Bragg resonator in case of failure of one of the resonators or controllers (e.g. the heating elements), as is described in relation to the examples above.

It will be appreciated in any of the examples above that any number of resonators may be used, where each may serve a different portion of the predetermined filter range. Thus, a plurality of resonators may be used to filter different portions of the predetermined filter range (e.g. N filters may filter 1/N th of the predetermined filter range). Each resonator may be configured to operate in a different sub-range of the predetermined filter range in normal use.

For example, a three resonator configuration may be used, where the predetermined filter range is divided into three portions. Two resonators which operate on portions of the predetermined filter range which are adjacent to the upper and lower boundaries of the predetermined filter range may be tuned to a range that is one third of the total operating range of the filter, the resonator which operates on the central portion of the predetermined filter range may instead be tuned over at least half of the predetermined filter range.

The optical filter as described in any of the examples above may comprise a processor configured to determine which of the resonators is to be operated based on a received target wavelength or may be communicable with such a processor. The optical filter may receive a signal indicating a wavelength which will correspond to the target wavelength, and the optical filter may then operate to select the relevant resonator to operate based on the location of the target wavelength in the predetermined filter range, as is described in relation to the examples above.

The optical filter may comprise, or be connected to, processing circuitry which may control the operation of the optical filter and can implement the methods described to herein. The processing circuitry can be configured or programmed to control the optical filter in the manner described herein. The processing circuitry can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the optical filter. In some embodiments, the processing circuitry can be configured to run software to perform the method described herein in respect of the optical filter. The software may be containerised according to some embodiments. Thus, in some embodiments, the processing circuitry may be configured to run a container to perform the method described herein in respect of the optical filter.

Briefly, the processing circuitry may be configured to instruct a controller to filter a target wavelength. The processing circuitry may determine a target wavelength to filter, and may send this information to a controller. The optical filter may optionally comprise or be connected to a memory. The memory can comprise a volatile memory or a non-volatile memory. In some embodiments, the memory may comprise a non-transitory media. Examples of the memory include, but are not limited to, a random access memory (RAM), a read only memory (ROM), a mass storage media such as a hard disk, a removable storage media such as a compact disk (CD) or a digital video disk (DVD), and/or any other memory.

The processing circuitry can be connected to the memory. In some embodiments, the memory may be for storing program code or instructions which, when executed by the processing circuitry, cause the optical filter to operate in the manner described herein in respect of the optical filter. For example, in some embodiments, the memory may be configured to store program code or instructions that can be executed by the processing circuitry to cause the optical filter to operate in accordance with the method described herein. Alternatively or in addition, the memory can be configured to store any information, data, messages, requests, responses, indications, notifications, signals, or similar, that are described herein. The processing circuitry may be configured to control the memory to store information, data, messages, requests, responses, indications, notifications, signals, or similar, that are described herein.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/ or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. An optical filter for an optical network, the optical filter being configured to adaptively add and/or remove a target wavelength in a predetermined filter range, the optical filter comprising:
a first resonator configured to have a first resonant wavelength outside a first sub-range of the predetermined filter range when a first resonance control variable of the first resonator is set at a first value, and a second resonant wavelength inside the first sub-range of the predetermined filter range when the first resonance control variable of the first resonator is set at a second value; and
a second resonator configured to have a third resonant wavelength outside a second sub-range of the predetermined filter range when a second resonance control variable of the second resonator is set at a third value, and a fourth resonant wavelength inside the second sub-range of the predetermined filter range when the second resonance control variable of the second resonator is set at a fourth value.

2. The optical filter as claimed in claim 1, wherein the first or the second resonance control variable is at least one of: a voltage of an electrical gate of the first or the second resonator or a temperature of the first or the second resonator.

3. The optical filter as claimed in claim 1, wherein the optical filter is configured to selectively alter the first resonance control variable of the first resonator to the second value which is a value at which the second resonant wavelength moves to the target wavelength, or the second resonance control variable of the second resonator to the fourth value which is a value at which the fourth resonant wavelength moves to the target wavelength.

4. The optical filter as claimed in claim 3, wherein when the target wavelength is closest to the first resonant wavelength, the first resonance control variable of the first resonator is altered, and when the target wavelength is closest to the third resonant wavelength, the second resonance control variable of the second resonator is altered.

5. The optical filter as claimed in claim 1, wherein the optical filter is configured to alter the value of the first resonance control variable of the first resonator when the target wavelength is in the first sub-range, and the optical filter is configured to alter the value of the second resonance control variable of the second resonator when the target wavelength is in the second sub-range.

6. The optical filter as claimed in claim 5, wherein when the target wavelength is in the first sub-range, the second resonator is configured to have the third resonant wavelength, and when the target wavelength is in the second sub-range, the first resonator is configured to have the first resonant wavelength.

7. The optical filter as claimed in claim 1, wherein the second resonator is configured so that the second resonance control variable is alterable to a fifth value so as to generate a resonant wavelength in the first sub-range of the predetermined filter range if the first resonance control value cannot be altered from the first value to the second value, and/or the first resonator is configured so that the first resonance control variable is alterable to a sixth value so as to generate a resonant wavelength in the second sub-range of the predetermined filter range if the second resonance control value cannot be altered from the third value to the fourth value.

8. The optical filter as claimed in claim 7, wherein altering the second resonance control variable to a fifth value so as to generate a resonant wavelength in the first sub-range of the predetermined filter range occurs if a failure relating to the first resonator is detected, and altering the first resonance control variable to a sixth value so as to generate a resonant wavelength in the second sub-range of the predetermined filter range occurs if a failure relating to the second resonator is detected.

9. The optical filter as claimed in claim 1, wherein the first sub-range extends over substantially half of the predetermined filter range and the second sub-range makes up substantially the remaining portion of the predetermined filter range.

10. The optical filter as claimed in claim 1, wherein the first sub-range and the second sub-range are separated by a guard range.

11. The optical filter as claimed in claim 10, wherein at least one of: the first resonant wavelength is in the guard range when the first resonance control variable of the first resonator is set at the first value; and the third resonant wavelength is in the guard range when the second resonance control variable of the second resonator is set at the third value.

12. The optical filter as claimed in claim 1, wherein at least one of: the first resonant wavelength is outside the predetermined filter range; and the third resonant wavelength is outside the predetermined filter range.

13. The optical filter as claimed in claim 1, wherein the first sub-range and the second sub-range do not overlap.

14. The optical filter as claimed in claim 1, wherein at least one of: at the first value of the first resonance control variable a first free spectral range of the first resonator is greater than the predetermined filter range; and at the third value of the second resonance control variable a second free spectral range of the second resonator is greater than the predetermined filter range.

15. The optical filter as claimed in claim 1, wherein the optical filter comprises no more than two resonators.

16. The optical filter as claimed in claim 1, wherein the optical filter comprises a plurality of resonators each having a resonant wavelength outside the predetermined filter range when the respective resonance control value of the resonators is at an off value, and having a resonant wavelength inside the predetermined filter range when the respective resonance control value of the resonators is at an on value.

17. The optical filter as claimed in claim 1, wherein the target wavelength is a wavelength of a channel to be added or removed in the optical network.

18. (canceled)

19. A method for using an optical filter configured to adaptively add and/or remove a target wavelength in a predetermined filter range, the method comprising:
altering a first resonance control variable of a first resonator from a first value to a second value, wherein the first resonator comprises a first resonant wavelength outside a first sub-range of the predetermined filter range when the first resonance control variable of the first resonator is at the first value, and a second resonant wavelength inside the first sub-range of the predetermined filter range when the first resonance control variable of the first resonator is at the second value; or
altering a second resonance control variable of a second resonator from a third value to a fourth value, wherein the second resonator comprises a third resonant wavelength outside a second sub-range of the predetermined filter range when the second resonance control variable of the second resonator is at the third value, and a fourth resonant wavelength inside the second sub-range of the predetermined filter range when the second resonance control variable of the second resonator is at the fourth value.

20. The method as claimed in claim 19, wherein the method further comprises altering the first resonance control variable of the first resonator to the second value which is a value at which the second resonant wavelength corresponds to the target wavelength, or the second resonance control variable of the second resonator to the fourth value which is a value at which the fourth resonant wavelength corresponds to the target wavelength.

21. (canceled)

22. The method as claimed in claim 19, wherein the method further comprises altering the value of the first resonance control variable of the first resonator when the target wavelength is in the first sub-range, and altering the value of the second resonance control variable of the second resonator when the target wavelength is in the second sub-range.

23-26. (canceled)
